(19) United States
(12) Patent Application Publication
(10) Pub. No.: US 2001/0034013 A1
(43) Pub. Date: Oct. 25, 2001

(54) System for encouraging recognition of beneficial acts

(76) Inventor: Sally E. Bennett, Vancouver, WA (US)

Correspondence Address: Richard C. Litman, LITMAN LAW OFFICES, LTD., P.O. Box 15035, Arlington, VA, 22215, US

(21) Appl. No.: 09/837,518

(22) Filed: Apr. 19, 2001

Related U.S. Application Data
(60) Provisional application No. 60/198,612, filed on Apr. 20, 2000.

(51) Int. Cl. G09B 19/00; G09B 1/06

(52) U.S. Cl. 434/238; 434/236

(57) ABSTRACT

A system providing for the encouragement of the recognition of beneficial acts (e. g., performance of various tasks, chores, good habits, etc.) includes a token holder, board or the like for the removable storage of a series of recognition tokens therein. Preferably, each person involved in the group (family household, etc.) has his/her own token holder and tokens. When a person performs some task, that person removes one of the tokens from his/her holder and places it at the location where the task was accomplished. The recipient or beneficiary of the task or chore later finds the token, and recognizes the efforts put forth by the: person leaving the token. The present invention may also include an identification marker for each participant, with the performer of the task placing the marker in a storage area of the board of the beneficiary of the task or other work performed.

### CROSS-REFERENCE TO RELATED APPLICATION

This application claims the benefit of U.S. Provisional Patent Application Ser. No. 60/198,612, filed Apr. 20, 2000.

### BACKGROUND OF THE INVENTION

1. Field of the Invention

The present invention relates generally to systems and methods for behavioral reinforcement, and more specifically to a method and apparatus for encouraging persons to recognize desirable actions or behavior by others. While the present system may be expanded to many different environments, it is particularly effective in the family household for educating children as to the household tasks which are performed for them by others, and encouraging their appreciation of such actions by others.

2. Description of the Related Art

Many, if not most, people tend to take for granted various aspects of their day to day living which are handled by others. Examples of such are trash pickup, community water and sewage services, etc. Most people tend not to give these services a second thought, on a day to day basis.

The typical family household is a similar case, in which most of the family members do not stop to consider all of the various tasks which are performed by others in the household. This is particularly true of younger children, who have not yet developed an understanding of the intricacies of many of the household chores (cooking, laundry, etc.) which are performed on their behalf.

This lack of consideration of the efforts of others may be a basic trait of human nature, but this does not mean that it cannot be corrected, or that persons cannot learn to appreciate the efforts of others. What is needed is a means of pointing out to persons the efforts of others on their behalf, particularly in the family household environment. The present invention responds to this need, by means of a series of tokens which may be placed at the site of a given beneficial effort or act by a person on the part of another. These tokens indicate to the object or recipient of the favor or effort, that some favor or effort has been directed to them, which they might otherwise have taken for granted. The recipient of the favor or object of the effort or behavior (e. g., picking up after a child, etc.) notices the token, and is thereby taught to recognize the efforts of others. The present system may also include centralized token receptacles for each participant member, with means for noting the specific individual performing a given task or favor.

A discussion of the related art of which the present inventor is aware, and its differences and distinctions from the present invention, is provided below.

U.S. Pat. No. 3,782,009 issued on Jan. 1, 1974 to Eula K. Darnell, titled “Behavior Modification Point Board,” describes a board having a series of rows for individual participants, and a series of columns describing various tasks to be accomplished. When a given task is accomplished or behavior is performed, a marker is placed in the appropriate slot defined by the intersection of the row and column. Various markers collected over a predetermined period of time may be exchanged for a marker or markers of larger denomination, and/or exchanged for a reward of some sort. The Darnell system is thus a means for rewarding good behavior by others, rather than a means of pointing out beneficial acts by one party to the recipients of the behavior, as in the present invention.

U.S. Pat. No. 5,013,246 issued on May 7, 1991 to Nancy L. C. Doyle, titled “Method Of Promoting Self-Esteem By Assembling A Personalized Kit,” describes a method and apparatus for recognizing desirable qualities in others. The Doyle kit includes a container and a series of chips, each printed with some desirable quality. A person places chips within the container which correspond to the qualities noted in another person, and gives the container and chips to the second person as a gift, in recognition of their qualities. Thus, the Doyle apparatus and method are essentially opposite the present invention, as the present invention provides means for a person to point out to others, various tasks or the like which have been performed by that person on behalf of others, rather than a means of noting the qualities of others.

U.S. Pat. No. 5,372,509 issued on Dec. 13, 1994 to Sally K. Brocato et al., titled “Healthy Choices Play And Reward Kit,” describes a doll and a series of positive statements referencing lack of alcohol or drug use and non-violence. A child is to apply an appropriate statement(s) to a portion of the doll for each day of the week in which the statements apply, thus encouraging the child to lead a drug, alcohol, and violence free life. While the Brocato et al. doll and method are directed to self recognition, they do not teach any means of promoting recognition of good behavior to others, nor any means of promoting the recognition of positive actions, as opposed to the passive actions promoted by Brocato et al. In contrast, the present invention provides a means for a person performing a positive action for others, to have that action recognized by others.

U.S. Pat. No. 5,470,235 issued on Nov. 28, 1995 to Stephen Papaleo, titled “Child Behavior Improvement System,” describes a series of receptacles, each providing for holding a small reward token of some sort. A series of instructions is also provided, with various instructions placed upon the cover of each receptacle. The instruction or chore must be completed before the person is allowed access to the reward within the receptacle. Thus, Papaleo provides a reward system for encouraging proper actions and behavior by a person, rather than a system for encouraging recognition of beneficial acts by another in which the performer of the beneficial act (task, etc.) places a token or the like where others will see it and take note of the accomplishment.

U.S. Pat. No. 5,573,404 issued on Nov. 12, 1996 to Willard S. Stawski, II, titled “Device And Process For Modifying Behavior Of Children,” describes a tabular device listing a series of desirable and undesirable behaviors, each having a monetary value. Performance of the desirable behaviors results in a monetary reward, while undesirable behavior results in a monetary penalty. The Stawski, II apparatus and method are thus more closely related to other systems of the prior art discussed above, than to the present invention. As with most other devices of the prior art, the Stawski, II system is a reward and punishment system depending upon the judgment of a party other than the person performing the tasks or behavior. In contrast, the present system does not provide rewards per se, but rather serves as a means for those performing various tasks to provide notice to others of those efforts.

U.S. Pat. No. 5,639,242 issued on Jun. 17, 1997 to Laura Lee Wilson, titled “Children's Educational Daily Responsibilities Learning System In Game Format,” describes a board having a peripheral track upon which markers may be placed to indicate progress in the completion of tasks or chores over a period of time. A second area includes movable lists of chores, which are transferred from one point to another as they are completed. Completion of chores allows the markers to be moved progressively along the board path until reaching the end, whereupon a monetary reward is entered in a record. The Wilson system thus more closely resembles the Stawski, II system and others discussed above, than the present invention wherein the task performer also provides notice.

U.S. Pat. No. 5,725,381 issued on Mar. 10, 1998 to Richard C. Kollath et al., titled “Motivation System For Children,” describes a table having schedule and reward areas. For each task performed in the schedule area, a reward is provided and listed in the reward area. Rewards may be edible goods or other objects, with their value being indicated by simulated currency which is provided to the child as tasks are completed or at some other time as desired. The Kollath et al. system is thus more closely related to the systems of the Stawski, II and Wilson U.S. Patents discussed above, than to the present invention, as the present system does not provide any reward for the performance of a task, nor does it require any judgment on the part of another party as to whether the task has been accomplished, or accomplished properly. The present system is instead a means for a person to ensure that their efforts are recognized by others, rather than a system to provide a reward for that person for the performance of a task.

U.S. Pat. No. 5,813,863 issued on Sep. 29, 1998 to Sharon R. Sloane et al., titled “Interactive Behavior Modification System,” describes a computer program having a series of scenarios which a person may work through step by step. Choices made by the person result in responses by the program as to the wisdom of those choices. The Sloane et al. program does not provide any reward per se, other than providing feedback to the person as to the wisdom of any given decisions. However, Sloane et al. do not provide any means for the person to provide notice to others of any beneficial tasks performed, as provided by the present invention.

Finally, U.S. Pat. No. 5,908,301 issued on Jun. 1, 1999 to Raymond Lutz, titled “Method And Device For Modifying Behavior,” describes a computer program for monitoring and modifying a behavior (e. g., eating, smoking, etc.). In the case of eating, the device monitors the number of bites and chews of the eater in order to reduce the total food intake of the eater by encouraging the eating process to be carried out over a longer period of time, rather than ingesting a relatively larger amount of food over a shorter period of time. The Lutz method does not provide any form of reward per se, other than perhaps enabling the user to achieve the desired goal. However, Lutz does not provide any means of notifying a person of any behavior directed to their well being by another person, as provided by the present invention.

None of the above inventions and patents, either singly or in combination, is seen to describe the instant invention as claimed.

### SUMMARY OF THE INVENTION

The present invention is an apparatus and method providing for the recognition of beneficial acts by a party. The apparatus of the present system essentially includes a holder or the like and a series of tokens removably stored in receptacles within the holder. Each person involved has a holder, tokens, and (if used) an identification marker. The holder may include means for holding an identification marker from another party, as well. The holder, various tokens, and identification markers may be configured in any manner desired without departing from the spirit of the invention.

The method of the present invention comprises the performance of some task or act by a benefactor person for a recipient person, with the benefactor withdrawing one of the tokens from their holder and placing it at the site of the work or task performed. If identification markers are used, the benefactor may also remove his/her identification marker from their holder and place it in a position for such purpose on the holder of the person for whom the work or task was performed. In this manner, the recipient of the good work may note that the benefactor had performed some task for them by seeing their identification marker in the recipient's holder, whereas they may not have occasion for some time to visit the location of the work performed (e. g., cleaning the interior of a car) and note the token placed at that site by the benefactor.

The present system thus provides recognition for a person who has occasion to perform ordinary or extraordinary tasks for another, with the performer of the tasks leaving behind a token to indicate that the task has been performed in order that the recipient of the work or behavior will note and appreciate the work performed. The present invention is particularly valuable in family situations, where children may take for granted the performance of daily chores (preparing meals, laundry, etc.) by adults in the household. The present invention serves as a reminder to the recipients of such actions, that these actions require effort. The result is that the recipients of such actions recognize and appreciate the efforts of those performing the tasks, and are encouraged to reciprocate in some manner.

Accordingly, it is a principal object of the invention to provide an improved method and apparatus providing for the recognition of beneficial acts by a party, and encouraging others to reciprocate such behavior.

It is another object of the invention to provide an improved apparatus for encouraging recognition of beneficial acts, comprising a holder including a series of tokens removably placed thereon.

It is a further object of the invention to provide an improved method of encouraging the recognition of beneficial acts, comprising the steps of performing a task for another, removing a token from the holder, and placing the token at the scene of the task performed for the discovery by the beneficiary of the task.

An additional object of the invention is to provide an improved system for encouraging recognition of beneficial acts, including identification markers which may be placed upon the holder of the beneficiary of a task by the performer of the task in order to provide notification of the performance of the task.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a fragmented and exploded perspective view of a token storage holder, exemplary tokens, and identification markers of the present invention.

FIG. 2A is a front elevation view of an exemplary recognition token of the present invention.

FIG. 2B is a rear elevation view of the token of FIG. 2A.

FIG. 3 is an exploded front elevation view of an alternative configuration token storage holder and tokens, according to the present invention.

FIG. 4A is a front elevation view of another alternative configuration token board and tokens removably secured thereto.

FIG. 4B is a rear elevation view of a token associated with the token holder of FIG. 4A, showing the means for removably securing the token of FIG. 4B to the board of FIG. 4A.

FIG. 5 is a front elevation view of yet another alternative configuration for a token holder and tokens according to the present invention.

FIG. 6 is a top and side perspective view of an alternative embodiment token having a hollow interior for the removable insertion of articles therein.

FIG. 7 is a perspective view of a further token embodiment.

FIG. 8 is a flow chart generally describing the steps in the method of carrying out the present invention.

Similar reference characters denote corresponding features consistently throughout the attached drawings.

### DETAILED DESCRIPTION OF THE PREFERRED EMBODIMENTS

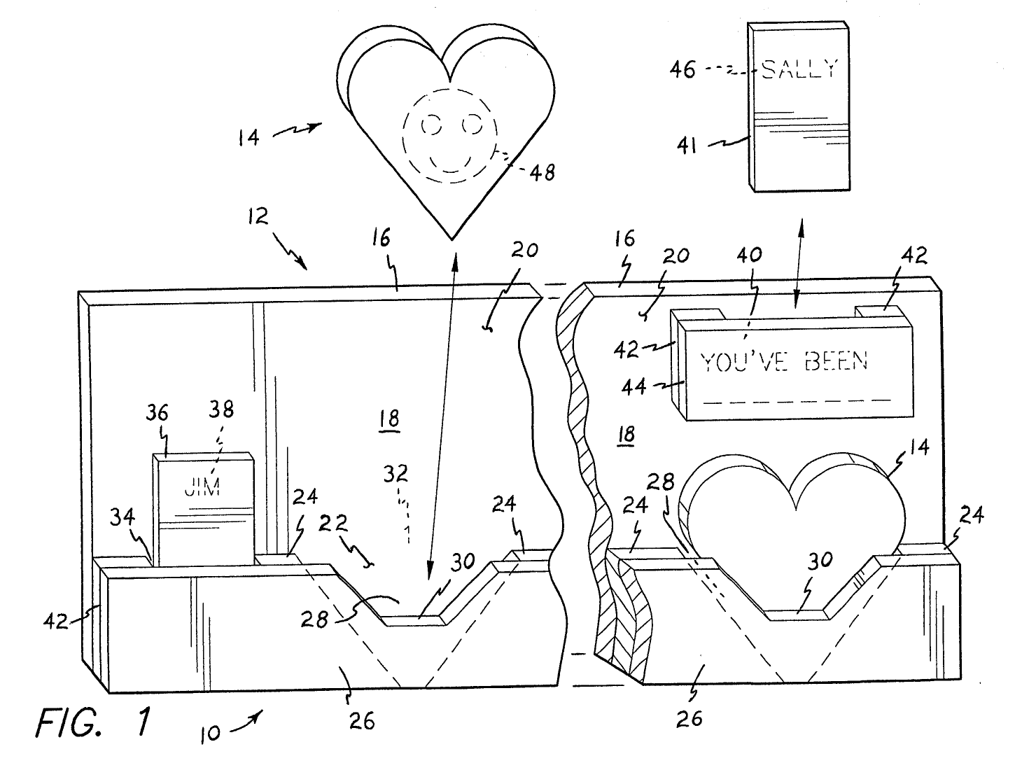

The present invention comprises various embodiments of an apparatus and method for encouraging the recognition of a beneficial act by a first or benefactor person, by a second person who is the recipient or beneficiary of the act, favor, task, etc. FIG. 1 illustrates a fragmented and exploded perspective view of a first embodiment apparatus for carrying out the present invention, comprising a token board assembly 10. The token board assembly 10 of FIG. 1 includes a recognition token holder board 12 and at least one (preferably a plurality of) recognition token(s) 14.

The token holder board 12 comprises a flat backboard 16 having a front surface 18 with an upper portion 20 and opposite lower portion 22. A series of spacers 24 are secured to the lower portion 22 of the front surface 18 of the board 12, with a front panel 26 installed across the spacers 24. The front panel 26, spacers 24, and the lower portion 22 of the backboard 12 define at least one (preferably a series of) recognition token pocket(s) 28 between the lower portion 22 of the backboard 12 and the front panel 26. The spacers 24 may be tapered as shown in FIG. 1 in order to preclude recognition tokens 14 falling through the pockets 28, and the front panel 26 may include a series of cutouts or reliefs 30 formed therein corresponding in number to the number of pockets 28 to facilitate the removal of recognition tokens 14 therefrom.

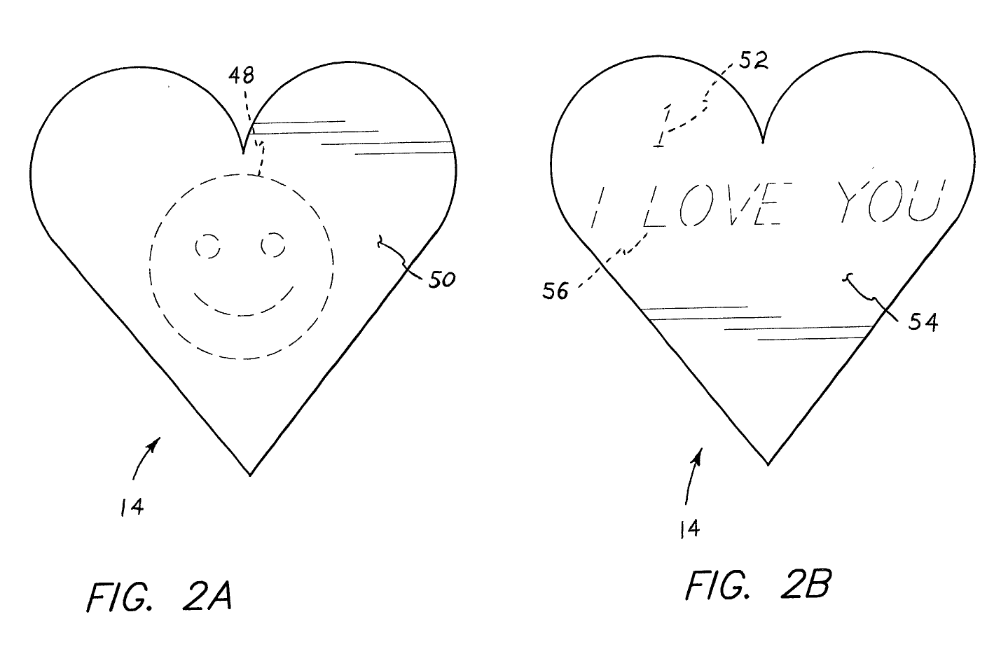

Preferably, the recognition token holder 12 includes a plurality of token holder pockets 28, as noted above. Each pocket 28 may be identified in some manner (e. g., numerically, as by the “1” shown in broken lines and indicated by the reference numeral 32 for the leftmost pocket 28 in FIG. 1. The recognition tokens 14 may include individual identification means corresponding to their storage pockets 28, as shown in FIG. 2B of the drawings and discussed further below.

The token holder 12 also preferably includes a single identification marker storage pocket 34, for removably holding a single identification marker 36 therein. The identification marker 36 normally resides within the pocket 34 provided for its storage, with the marker 36 including identification means 38 for identifying its owner. When equipped with a marker storage pocket 34, the holder 12 will also be provided with a separate (adjacent, or spaced apart from) identification marker display pocket 40, for the temporary and removable placement of an identification marker 41 of another party. These identification marker pockets 34 and 40 may be formed in the same manner as that used for forming the recognition token pockets 28, by means of spacers 42 and a front panel 44 (or a continuation of the front panel 26) extending across the spacers 42. The present invention provides for the second identification marker 42 to be that of another party from the person controlling the token holder 12 with its identification marker 36 and storage pocket 34, with the second marker 41 thus including appropriate identification means 46 thereon.

FIGS. 2A and 2B respectively illustrate front and rear elevation views of the recognition token 14 of FIG. 1. The token 14 may include a decorative pattern 48 on the front surface 50 thereof (“smiley face,” caricature, decoration, or design, etc.), with individual identification means 52 corresponding to the individual pocket identification reference character 32 with which the recognition token 14 is associated, disposed upon the back face 54 of the recognition token 14. An additional message, design, embellishment, etc. 56 may also be provided on the back face 54 of the token 14, if so desired. The individual identification of tokens and their respective storage pockets is unnecessary where only a single storage pocket is provided in a holder, and is not required for multiple pocketed holders. However, the numbering or other correlation of each recognition token with a corresponding pocket, may be of assistance to small children in learning the Arabic numeral system, alphabet, or other systems.

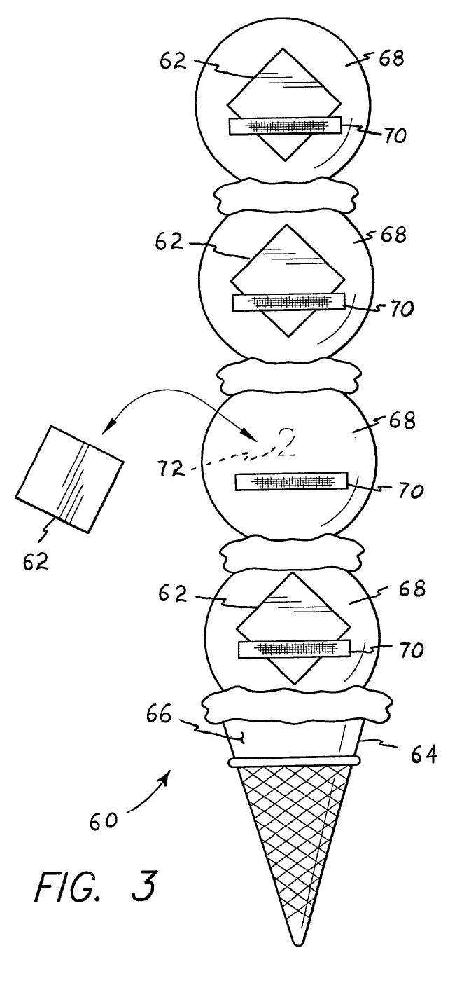

The above described token holder board 12 of FIG. 1 has a generally rectangular form, with a series of pockets 28 formed for removably holding a like number of cardioid (valentine heart shaped) recognition tokens 14 therein, as shown in FIGS. 1 through 2B. However, it will be seen that the token holder and recognition tokens may be formed to have any practicable shape or configuration, as desired. FIG. 3 of the drawings illustrates another embodiment of the present inventive structure, in which the token holder 60 is in the form of a multiple scoop ice cream cone, with the recognition tokens 62 each having a trapezoidal shape.

The recognition token holder 60 generally comprises an elongate flat backboard 64 having an outline configured to represent a multiple scoop ice cream cone, as illustrated in FIG. 3. The board 64 has a front surface 66 configured with the same theme, with a plurality of separate recognition token storage areas 68 linearly disposed thereon, with each area 68 corresponding to one of the linearly stacked scoops of ice cream of the cone. Each of the trapezoidal or diamond shaped recognition tokens 62 is secured in its respective storage position 68 by an elastic band 70 extending thereacross. Each of the storage positions 68 may be differentiated from one another by some form of identification, as by the reference numeral 72 or other means as desired, with the recognition tokens 62 being identified and/or embellished in a like manner, as illustrated in the heart shaped token 14 of FIGS. 2A and 2B.

The ice cream cone recognition token holder 60 configurations illustrated in FIG. 3 is exemplary, and it will be seen that any one of an innumerable number of different configurations of token holders may be formed in keeping with the present invention. Also, while no identification holder means is illustrated with the token holder 60 of FIG. 3, it will be seen that such identification holder means may be added if so desired, using the same retention means (e. g., elastic bands) as used for securing the recognition tokens 62 in FIG. 3, or other retention means as desired. It will be noted that a continuous segmented elastic band may be used in lieu of the pockets 28 of the board 12 of FIG. 1, if so desired.

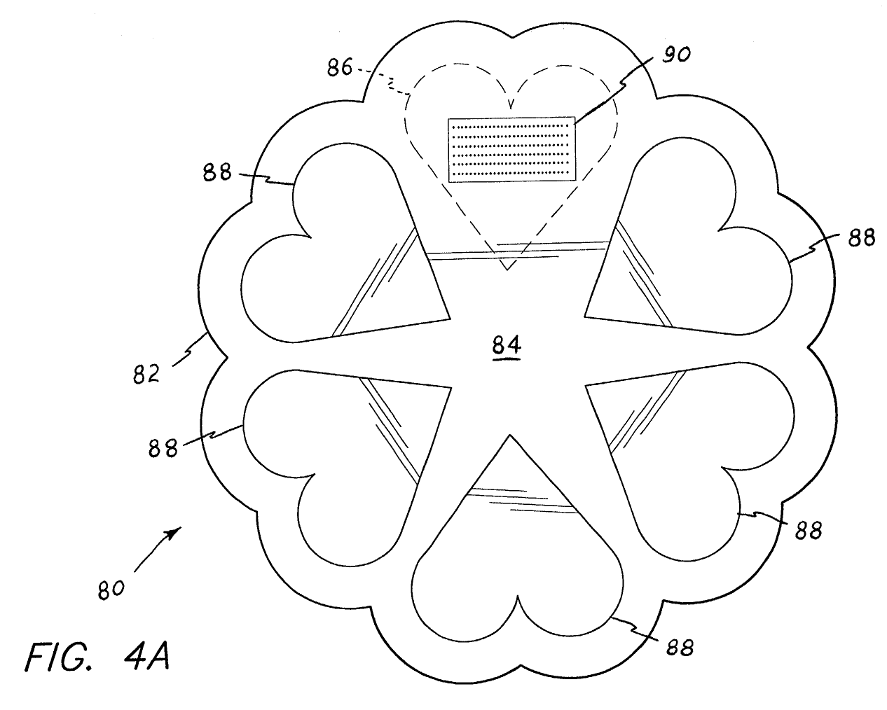

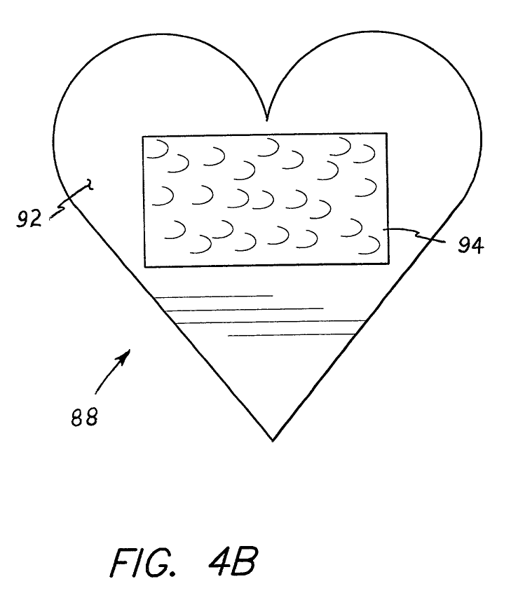

FIGS. 4A and 4B illustrate yet another configuration for the present invention, with a recognition token holder and token assembly 80. The token holder 82 of the assembly 80 comprises a flat backboard having a generally circular pattern with a scalloped edge, somewhat reminiscent of a flower blossom. The front surface 84 of the token holder board 82 includes a series of separate recognition token storage areas 86 disposed in a generally circular pattern thereon. The scalloped upper or outer edges of the valentine heart shaped recognition tokens 88, are configured to fit within the scallops of the board 82 to provide a neat and attractive display, although it will be seen that recognition tokens having different shapes or configurations may be used with the token holder 82 of FIG. 4A, if so desired.

The storage positions 86 and corresponding recognition tokens 88 each include mating or complementary attachment means thereon, for removably securing the recognition tokens 88 to their respective storage areas 86 of the board 82. The empty storage area 86 at the top of the token holder 82 of FIG. 4A, reveals a first type of hook and loop fastening material (e. g., hook material 90) disposed thereon. The back surface 92 of the recognition token 88 of FIG. 4B, discloses the mating second type of hook and loop material (e. g., loop material 94) disposed thereon. It will be seen that the two mating materials may be reversed on the holder board 82 and recognition token 88, and/or different fastener means (e. g., mating snaps, etc.) may be used to secure the tokens 88 removably to the board 82, as desired.

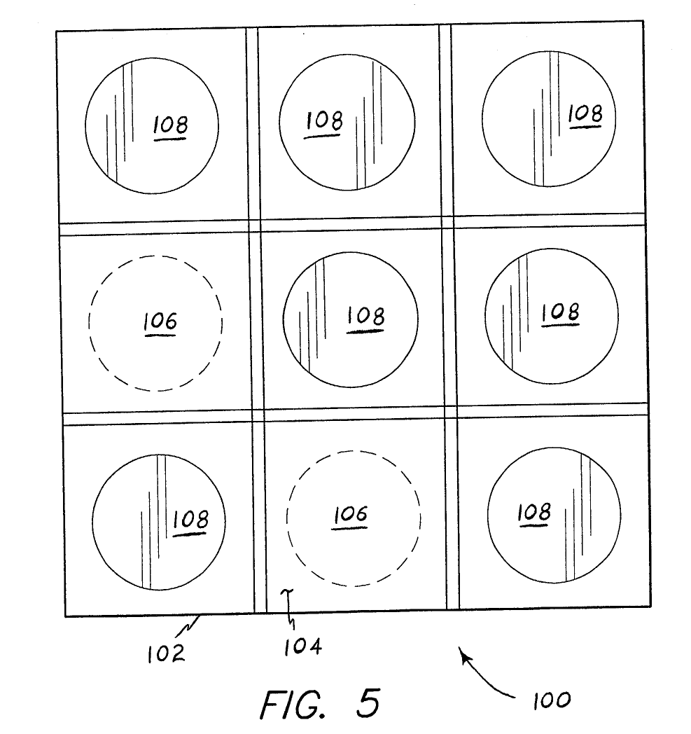

FIG. 5 discloses yet another embodiment of the present invention, wherein the token holder and token assembly 100 has a generally rectilinear configuration resembling a tic-tac-toe board layout. The assembly 100 comprises a flat backboard 102 having a generally square configuration, with a front surface 104 including a series of recognition token storage areas 106 disposed thereon, two of which are indicated in broken lines with the otherwise obscuring tokens 108 removed. The token storage areas 106 are preferably arranged in a rectilinear matrix, i. e., three rows of three columns each, as in a conventional tic-tac-toe game.

Each of the areas 106 includes means for the removable attachment of a recognition token 108 thereon, generally in the manner of the other token holder devices shown in FIGS. 1, 3, and 4A and discussed further above. The recognition token attachment means may comprise conventional first and second mating hook and loop fastener materials 90 and 94 (e. g., Velcro, tm) as described for the token holder board 82 of FIG. 4A, elastic band means 70 as used for the token holder 64 of FIG. 3, or other temporary attachment means (snap fasteners, etc.) as desired.

The recognition tokens 108 may be of any shape or configuration desired, e. g., the circular or round shape shown in FIG. 5. Other shapes or configurations may be used with the tic-tac-toe board configuration 102 of FIG. 5 as desired, e. g., the valentine heart shaped tokens of FIGS. 1, 2A, 2B, 4A and 4B, the rhomboid or diamond shaped tokens of FIG. 3, or any other practicable shape or configuration as desired.

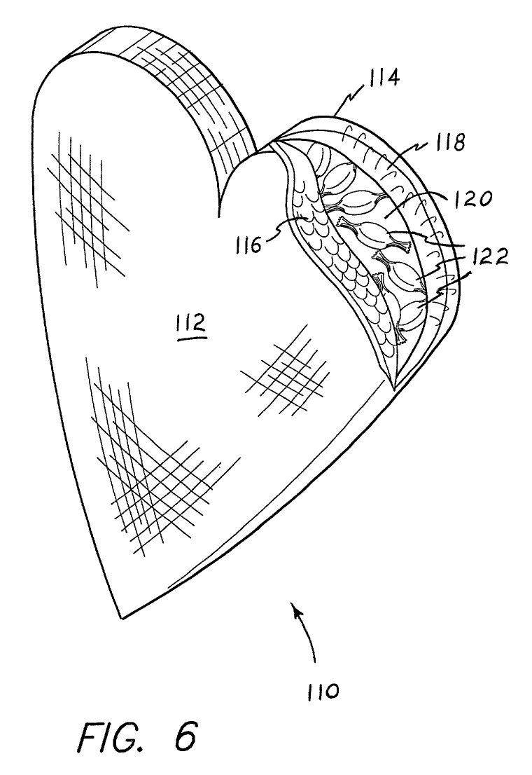

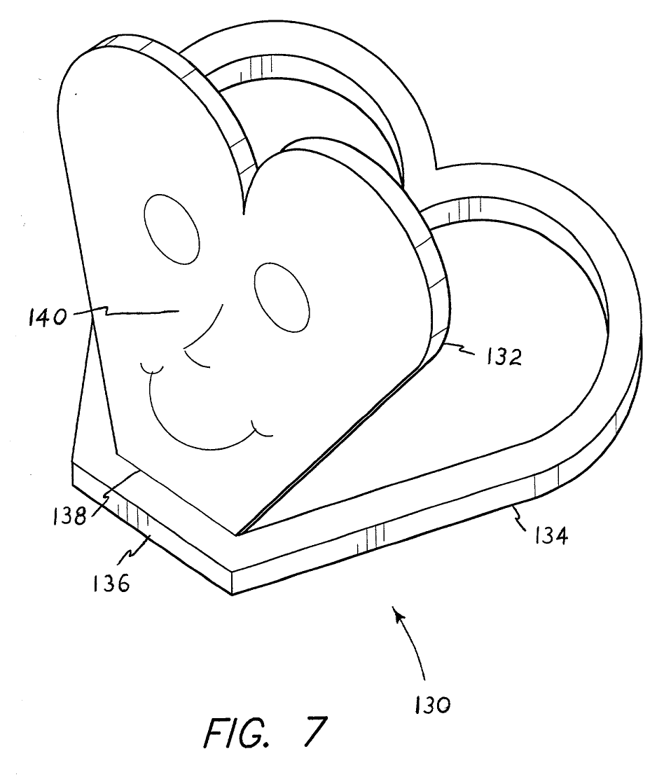

FIGS. 6 and 7 illustrate still further embodiments of recognition tokens which may be used with the present system for the encouragement of recognition of beneficial acts. The recognition token 110 of FIG. 6 may be formed of two sheets 112 and 114 of a flexible fabric or other material, stitched about the majority of the periphery. One portion of the edge is left unstitched, with mating fastener material (e. g., first and second portions 116 and 118 of hook and loop material, or mating snaps, etc.) being applied to the two respective open edges. The fastener material 116 and 118 provides for the openable closure of the hollow interior 120 of the token 110 as desired. Access to the interior 120 allows a benefactor to place a few pieces of candy 122, a small toy or other gift, a note, etc., as desired, within the hollow token 110, for the beneficiary to find and enjoy.

The recognition token 130 of FIG. 7 is configured for a standup presentation. The token 130 has a central portion 132 with a peripheral portion 134 separated from the central portion 132 about most of the periphery, but joined to the central portion 132 along a base edge 136. The recognition token 130 is preferably formed of a flexible material, with the juncture 138 between the central portion 132 and peripheral portion 134 acting as a live hinge. This enables the central portion 132 to be adjustably folded angularly relative to the peripheral portion 134, with the peripheral portion 134 serving as a base and the central portion 132 folded to a generally upright orientation. A caricature 140 or the like may be provided upon the central portion 132, if desired.

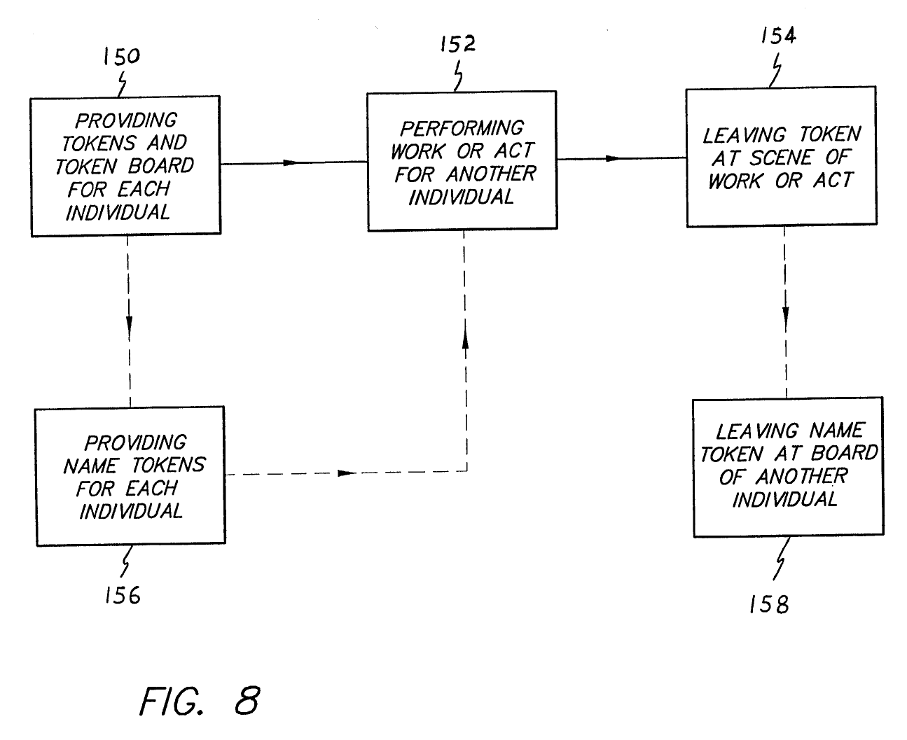

FIG. 8 generally discloses the steps in the method of using the above described apparatus of the present system for encouraging recognition of beneficial acts of one person toward another. The present system essentially comprises the placement of one of the recognition tokens of the present invention at the location of al beneficial act, where the beneficiary or recipient of the act will find it and recognize that some beneficial act or act of kindness was performed toward them rather than taking such acts for granted.

Preferably, each member of a group (e. g., family household, school class, etc.) is provided with his or her own token holding or storage board, as indicated generally by the first step 150 of FIG. 8. Preferably several recognition tokens, and a corresponding number of positions on the board for removable placement and storage of the tokens (e. g., the storage pockets of the board of FIG. 1, elastic means of FIG. 3, hook and loop fastener means of FIGS. 4A and 4B, etc.), are provided for each individual. The board positions and tokens may be marked with some form of location identifier means (e. g., numbers, letters, etc.) to define the specific storage location for each token on a given board, as noted for the board and tokens of FIGS. 1, 2A, and 2B.

Alternatively, a larger board could be provided, with each member of the group being assigned an area of the larger board for the storage of his or her tokens. The advantage of individual boards is that they may be placed where convenient for each member of the group, with their configurations and decor being configured as desired for different individuals.

Whenever a benefactor person performs some act for al beneficiary person (e. g., picking up after a child, performing some household chore for another, assisting another person in some project, etc.), as indicated by the second step 152 of FIG. 8, the benefactor removes one of the recognition tokens (flat token of FIGS. 1 through 5, hollow token of FIG. 6, standup token of FIG. 7, etc.) from his or her token holder and leaves it at the scene of the beneficial work or act, as indicated generally by the third step 154 of FIG. 8. With each person of the group having his or her own distinctively configured set of recognition tokens (e. g., heart shaped for one member, circular for another, etc.), the beneficiary may easily determine just which member of the group performed the beneficial act.

However, the present invention also provides other means for identifying the benefactor, so the beneficiary may express appreciation. In the event that all of the recognition tokens for all members of the group are essentially identical, the beneficiary of an act may not be able to determine readily just who the benefactor was for a given act, if there are three or more persons in the group. Also, a beneficiary may not become immediately aware of a beneficial act, if that beneficial act was performed remotely from the beneficiary. An example might be a benefactor performing some minor maintenance upon the beneficiary's car, after the beneficiary has parked the car for the evening. The beneficiary may not become aware of the act until the next day, or at least the next time he or she has occasion to operate the vehicle.

Accordingly, the present system provides additional recognition means in the form of name tokens or identification markers for each participant. A single such name token or identification marker may be provided with each token holder apparatus, as shown in FIG. 1 and indicated by the optional fourth step 156 of FIG. 8 of the drawings; more such markers may be provided as desired with each token storage apparatus. Each token storage or holder board includes an identification marker storage pocket or other area for each such marker, as shown in FIG. 1. Each board will also include an identification marker or name token display pocket or other area when the name tokens or identification markers are used, as illustrated to the upper right portion of the token board of FIG. 1.

When a person performs a beneficial act, he or she withdraws his or her name token or identification marker from its storage position of the board and places it in the display position of the board of the beneficiary of the act, as indicated generally by the optional fifth step 158 of FIG. 8. In this manner, the beneficiary is made aware of a beneficial act toward him or her, by noting the identification marker of the benefactor person being displayed in the display position of the beneficiary's board, even if the beneficial act has not yet become obvious to the beneficiary. The result is that beneficiaries of previously unappreciated beneficial acts toward them, are made aware of such acts and are encouraged to appreciate such beneficial acts.

In summary, the present system for encouraging the recognition of beneficial acts of one individual toward another, provides a means for encouraging the appreciation of the efforts of one individual toward another. The present system may be implemented in a number of different environments, from the workplace to the schoolroom, but is particularly valuable in the family household where the efforts of some members of the group tend to be taken for granted by others. This is particularly true of small children of the efforts of their parents, as children grow up seeing the work and acts of daily care from the time of their birth. The present system provides a gentle means of making others aware of one's efforts, and encourages the recognition and appreciation of those efforts by the beneficiary of the act. The present system is nonjudgmental, in that no party considers the value of any particular work or act performed, in carrying out the present system. As all members of a group begin to note the acts of others and express their appreciation of the day to day efforts of others in their group, the present invention becomes a self perpetuating system which encourages all members of a group to work for others in the group and for the good of the group in order to achieve such recognition from others in the group, thus benefitting all persons in the group and making the efforts of all in the group appreciated.

It is to be understood that the present invention is not limited to the embodiments described above, but encompasses any and all embodiments within the scope of the following claims.

I claim:

1. An apparatus for providing for recognition of beneficial acts of a benefactor person to a beneficiary person, comprising:
a recognition token holder for each person;
at least one recognition token for each said recognition token holder, configured for placing by the benefactor person at the site of a beneficial act by the benefactor person, for indicating the beneficial act to the beneficiary person; and
means for removably securing said at least one recognition token to the corresponding said recognition token holder, for access by the benefactor person as required.

2. The apparatus according to claim 1, wherein said means for removably securing said at least one recognition token to said recognition token holder is selected from the group consisting of an elastic band disposed on said token holder and mating hook and loop fastener material disposed upon said token holder and upon said at least one recognition token.

3. The apparatus according to claim 1, wherein:
said token holder includes a plurality of recognition token storage positions for each said recognition token holder; and
said at least one recognition token comprises a plurality of recognition tokens equal in number to said plurality of recognition token storage positions of each said recognition token holder.

4. The apparatus according to claim 3, further including:
means for distinguishing each of said storage positions of each said recognition token holder from one another; and
means for distinguishing each of said recognition tokens of each said recognition token holder from one another.

5. The apparatus according to claim 1, further including:
at least one identification marker for temporary placing in said recognition token holder of the beneficiary person, by the benefactor person;
storage means for said at least one identification marker in each said recognition token holder; and
display means for said at least one identification marker of the benefactor person on said recognition token holder of the beneficiary person, for indicating the performance of a beneficial act by the benefactor person to the beneficiary person.

6. The apparatus according to claim 5, wherein:
at least one said recognition token holder comprises a flat backboard having a front surface with an upper portion and a lower portion;
a plurality of spacers disposed upon said lower portion of said front surface of said backboard;
a front panel extending across said spacers and defining a plurality of recognition token pockets between said front panel and said backboard;
said front panel further defining a single identification marker storage pocket; and
a single identification marker display pocket separately disposed upon said backboard.

7. The apparatus according to claim 1, wherein:
at least one said recognition token holder comprises an elongate flat backboard having a front surface with a plurality of separate recognition token storage areas linearly disposed thereon.

8. The apparatus according to claim 1, wherein:
at least one said recognition token holder comprises a generally circular flat backboard having a front surface with a plurality of separate recognition token storage areas circularly disposed thereon;
each of said recognition token storage areas including first recognition token attachment means disposed thereon; and
each said recognition token including second recognition token attachment means disposed thereon, for removably attaching to said first recognition token attachment means of each of said recognition token storage areas of each said recognition token holder.

9. The apparatus according to claim 1, wherein:
at least one said recognition token holder comprises a generally square flat backboard having a front surface with a plurality of separate recognition token storage areas disposed thereon in a rectilinear matrix;
each of said recognition token storage areas including first recognition token attachment means disposed thereon; and
each said recognition token including second recognition token attachment means disposed thereon, for removably attaching to said first recognition token attachment means of each of said recognition token storage areas of each said recognition token holder.

10. The apparatus according to claim 1, wherein:
each said recognition token is configured from the group consisting of cardioid, trapezoid, and circular configurations.

11. The apparatus according to claim 1, wherein:
at least one said recognition token is hollow with an accessible interior, for removably placing at least one article therein.

12. The apparatus according to claim 1, wherein:
at least one said recognition token includes a central portion and a peripheral portion secured to one another at a base edge;
said peripheral portion being adjustably angularly disposed to said central portion and defining a base for supporting said central portion in an upright orientation.

13. A method for the recognition of beneficial acts of a benefactor person to a beneficiary person, comprising the following steps:
(a) providing a recognition token holder for each person;
(b) further providing at least one recognition token for each recognition token holder;
(c) further providing means for removably securing each recognition token to the corresponding recognition token holder, for access by the benefactor person as required;
(d) performing a beneficial act by the benefactor person;
(e) removing the recognition token from the recognition token holder of the benefactor person, by the benefactor person; and
(f) placing the recognition token of the benefactor person at the scene of the beneficial act by the benefactor person, for indicating to the beneficiary person that the beneficial act was performed by the benefactor person.

14. The method according to claim 13, wherein:
(a) said token holder has a plurality of recognition token storage positions; and
(b) the step of providing at least one recognition token comprises providing a plurality of recognition tokens equal in number to the plurality of recognition token storage positions.

15. The method according to claim 14, further including the steps of:
(a) distinguishing each storage position of each recognition token holder from one another; and
(b) distinguishing each recognition token of each recognition token holder from one another.

16. The method according to claim 13, further including the steps of:
(a) providing at least one identification marker for each person;
(b) further providing storage means for each identification marker in each corresponding recognition token holder;
(c) further providing display means for an identification marker on each recognition token holder; and
(d) indicating to the beneficiary person the performance of a beneficial task by the benefactor person, by temporarily placing the identification marker of the benefactor person in the recognition token holder of the beneficiary person by the benefactor person after performing a beneficial task.

17. The method according to claim 13, wherein the step of providing means for removably securing each recognition token to each recognition token holder, comprises providing a storage pocket in each recognition token holder for each recognition token.

18. The method according to claim 13, further including the steps of:
(a) providing a hollow interior for each recognition token; and
(b) placing at least one article within the hollow interior of the recognition token.

19. The method according to claim 13, further including the steps of:
(a) forming each recognition token with a central portion and a peripheral portion secured to one another at a base edge;
(b) adjustably angularly positioning the peripheral portion relative to the central portion for using the peripheral portion as a base for supporting the central portion in an upright orientation.
